(19) United States
(12) Patent Application Publication
(10) Pub. No.: US 2011/0003107 A1
(43) Pub. Date: Jan. 6, 2011

(54) OPTICAL DISCS WITH UNIFORM APPEARANCE

(75) Inventors: Gurpreet Singh JUNEJA, New Dehli (IN); Rajagopal Sundara Raman, New Dehli (IN); Rajeev Jindal, New Dehli (IN); Anil Bhargava, New Dehli (IN)

Correspondence Address: PILLSBURY WINTHROP SHAW PITTMAN, LLP, P.O. BOX 10500, MCLEAN, VA, 22102, US

(73) Assignee: MOSER BAER INDIA LIMITED, New Dehli (IN)

(21) Appl. No.: 12/557,266

(22) Filed: Sep. 10, 2009

(30) Foreign Application Priority Data
Jul. 1, 2009 (IN) 1562/CHE/2009

(51) Int. Cl. B32B 3/02; B29C 69/00; B05D 5/00; B41J 2/015

(52) U.S. Cl. 428/64.4; 264/241; 427/256; 347/20

(57) ABSTRACT

An optical disc with uniform appearance, a method and system for manufacturing an optical disc, and a method and system for printing on an optical disc are provided. The optical disc includes a hub area formed between a first inner radius and a first outer radius, and a data area formed between a second inner radius and a second outer radius. The hub area and the data area include grooves and lands formed between a predetermined radius and the second outer radius. The predetermined radius lies at the first inner radius or between the first inner radius and the first outer radius. This enables uniform appearance across an area between the predetermined radius and the second outer radius.

### RELATED APPLICATIONS

This application is related to “Storing Media with Undifferentiated Visual Aspect,” filed co-currently with this application, having Attorney Docket No. 074462-0379152, which is incorporated herein in its entirety by reference.

### BACKGROUND

The embodiments herein relate, in general, to optical discs. More particularly, the embodiments relate to an optical disc with uniform appearance.

Optical discs typically have a central punch area, a hub area and a data area. The hub area is generally transparent, and is made of plastic. On the other hand, the data area has several layers that enable recording and/or reproducing data, and therefore, is opaque. FIG. 1 (Prior Art) illustrates an optical disc 100. Optical disc 100 includes a punch area 102, a hub area 104, and a data area 106. With reference to FIG. 1, hub area 104 is transparent, while data area 106 is opaque. This gives optical disc 100 a non-uniform appearance across hub area 104 and data area 106. Consider, for example, that optical disc 100 has a printable surface that spans hub area 104 and data area 106. When an image is printed onto the printable surface, the image appears non-uniform across hub area 104 and data area 106. This causes various hindrances in operational and marketing aspects, for example, related to utility and acceptability.

Various attempts have been made in the past, to overcome the aforementioned problems. For example, wide sputtering of optical discs has been attempted. However, these attempts have failed to achieve uniformity in the appearance of optical discs so formed.

In light of the foregoing discussion, there is a need for an optical disc that has a uniform appearance, enables uniform appearance of an image printed onto it, and overcomes the above-mentioned hindrances.

### SUMMARY

An embodiment is to provide an optical disc with uniform appearance (and manufacturing and printing methods and systems thereof).

Another embodiment is to provide the optical disc that enables uniform appearance of an image printed onto it.

Yet another embodiment is to provide the optical disc that overcomes various technical hindrances in operational and marketing aspects, for example, related to utility and acceptability.

Embodiments herein provide an optical disc with uniform appearance. The optical disc includes a punch area at a centre of the optical disc, a hub area surrounding the punch area, and a data area surrounding the hub area. The hub area is formed between a first inner radius and a first outer radius. The data area is formed between a second inner radius and a second outer radius. The second inner radius is greater than the first inner radius, and the second outer radius is greater than the first outer radius. The first inner radius and the first outer radius may, for example, range between 7.5 mm and 16.5 mm. The second inner radius and the second outer radius may, for example, range between 16.5 mm and 65 mm.

The hub area and the data area include grooves and lands formed between a predetermined radius and the second outer radius. The predetermined radius lies at the first inner radius or between the first inner radius and the first outer radius. This enables uniform appearance across an area between the predetermined radius and the second outer radius.

The optical disc includes a printable layer formed between the predetermined radius and the second outer radius, wherein the optical disc has a uniform appearance of an image printed onto the printable layer across the area between the predetermined radius and the second outer radius. The printable layer may, for example, be made of paper, plastic, polyvinyl pyrrolidone (PVP), polyvinyl alcohol (PVOH), polyvinyl acetate (PVA), polymers, synthetic resins, or combinations thereof.

In accordance with an embodiment herein, the optical disc includes one or more dye layers formed over the grooves and lands, a reflective layer formed over the one or more dye layers, and a protective layer formed over the reflective layer. The one or more dye layers may, for example, be made of cyanine, phthalocyanine, azo compounds, formazan, or combinations thereof. The reflective layer may, for example, be made of metals, metallic alloys, metal-containing compounds, or combinations thereof.

As mentioned above, the optical disc so formed enables uniform appearance across the area between the predetermined radius and the second outer radius, and enables uniform appearance of the image printed onto the printable layer. This enhances the utility and acceptability of the optical disc.

### BRIEF DESCRIPTION OF DRAWINGS

Embodiments herein will hereinafter be described in conjunction with the appended drawings provided to illustrate and not to limit the scope of the claims, wherein like designations denote like elements, and in which:

FIG. 1 (Prior Art) illustrates an optical disc;

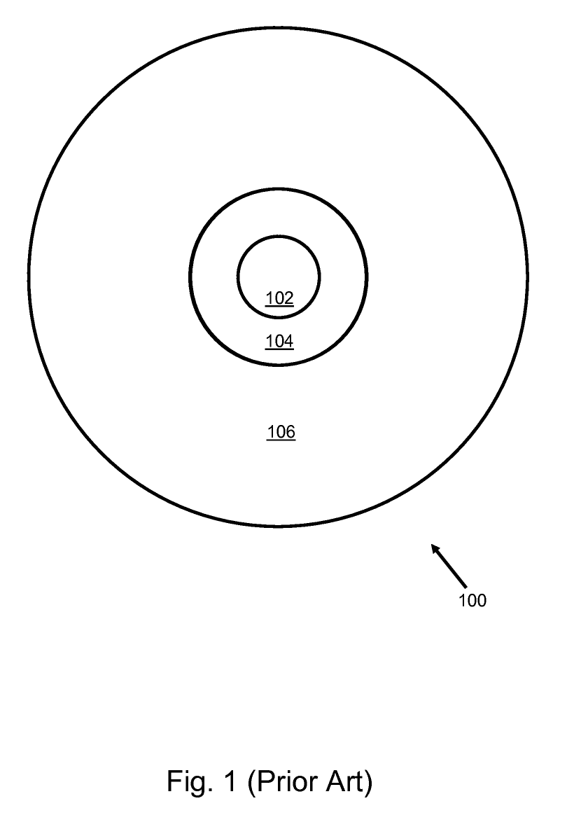

FIG. 2 illustrates an optical disc, in accordance with an embodiment herein;

FIG. 3 illustrates an optical disc, in accordance with another embodiment herein;

FIG. 4 illustrates various layers of a storing medium, in accordance with an embodiment herein;

FIG. 5 illustrates a system for manufacturing an optical disc, in accordance with an embodiment herein;

FIG. 6 illustrates a method of manufacturing an optical disc, in accordance with an embodiment herein;

FIG. 7 illustrates a method of manufacturing an optical disc, in accordance with another embodiment herein;

FIG. 8 illustrates a system for printing on an optical disc, in accordance with an embodiment herein; and

FIG. 9 illustrates a method of printing on an optical disc, in accordance with an embodiment herein.

### DETAILED DESCRIPTION

As used in the specification and claims, the singular forms “a”, “an” and “the” include plural references unless the context clearly dictates otherwise. For example, the term “an optical disc” may include a plurality of optical discs unless the context clearly dictates otherwise. A term having “-containing” such as “metal-containing” contains a metal but is open to other substances, but need not contain any other substance other than a metal.

Embodiments herein provide an optical disc with uniform appearance, a method and system for manufacturing an optical disc, and a method and system for printing on an optical disc. In the description of the embodiments herein, numerous specific details are provided, such as examples of components and/or mechanisms, to provide a thorough understanding of embodiments herein. One skilled in the relevant art will recognize, however, that an embodiment herein can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments herein.

### GLOSSARY

Optical disc: An optical disc is for recording and/or reproducing data.
Substrate: A substrate is for providing support to the optical disc.
Punch area: A punch area is a hole through a centre of an optical disc.
Hub area: A hub area is a two-dimensional area surrounding the punch area.
Data area: A data area is a two-dimensional area, surrounding the hub area, on and/or from which data is recorded and/or reproduced.
Grooves and lands: A groove is a three-dimensional recessed region formed on the substrate. Grooves are generally formed in a concentric or spiral manner. A land is a two-dimensional area formed between two adjacent grooves.
Printable layer: A printable layer is for printing an image onto it. The printable layer may also be referred to as a printed material.
Dye layer: A dye layer is for recording data onto it. The dye layer is formed over the grooves and lands on the substrate.
Reflective layer: A reflective layer is formed over the dye layer. A light beam falling on the optical disc is reflected off the reflective layer, and is received by a light detector during recording and/or reproducing of data.
Protective layer: A protective layer is formed over the reflective layer. The protective layer protects underlying layers from external factors, such as scratches and dirt.
Molding unit: A molding unit is for molding a polymeric material to form the substrate. The molding unit is adapted to form grooves and lands over the substrate, as required.
Printable-layer forming unit: A printable-layer forming unit is for forming a printable layer over the substrate.
Dye-layer forming unit: A dye-layer forming unit is for forming one or more dye layers over the grooves and lands.
Reflective-layer forming unit: A reflective-layer forming unit is for forming a reflective layer over the one or more dye layers.
Protective-layer forming unit: A protective-layer forming unit is for forming a protective layer over the reflective layer.
Disc support: A disc support is for receiving the optical disc.
Printing head: A printing head is for printing an image onto the printable layer of the optical disc.
Disc recorder: A disc recorder is for recording data onto the optical disc.
Uniform appearance: A region is said to have a uniform appearance when it has substantially the same intensity of whiteness across the region. The intensity of whiteness may, for example, be measured in terms of the Lab color space.
Lab color space: The Lab color space is a color-opponent space in which component ‘L’ represents lightness of color, component ‘a’ represents its position between red/magenta and green, and component ‘b’ represents its position between yellow and blue. The Lab color space is designed to approximate human vision. Its component ‘L’ closely matches human perception of lightness.

The optical disc includes a punch area at a centre of the optical disc, a hub area surrounding the punch area, and a data area surrounding the hub area. The hub area is formed between a first inner radius and a first outer radius. The data area is formed between a second inner radius and a second outer radius. The second inner radius is greater than the first inner radius, and the second outer radius is greater than the first outer radius. In accordance with an embodiment herein, the second inner radius is equal to the first outer radius.

Optical discs are available in various types and sizes. Examples of optical discs include, but are not limited to, Compact Discs (CDs), Digital Versatile Discs (DVDs), High-Definition DVDs (HD-DVDs), High-Definition Versatile Discs (HVDs), Blu-ray Discs (BDs), MiniDiscs (MDs), Universal Media Discs (UMDs), and Laser Discs (LDs). The overall radius of optical discs may, for example, range between 30 mm and 65 mm. The first inner radius and the first outer radius may, for example, range between 7.5 mm and 16.5 mm. The second inner radius and the second outer radius may, for example, range between 16.5 mm and 65 mm.

The hub area and the data area include grooves and lands formed between a predetermined radius and the second outer radius. The predetermined radius lies at the first inner radius or between the first inner radius and the first outer radius. This enables uniform appearance across an area between the predetermined radius and the second outer radius.

As mentioned above, a region is said to have a uniform appearance when it has substantially the same intensity of whiteness across the region. The intensity of whiteness may, for example, be measured in terms of the Lab color space, using a modified form of spectrophotometer. An example of such a spectrophotometer is the Gretag-Macbeth spectroscan.

The optical disc includes a printable layer formed between the predetermined radius and the second outer radius, wherein the optical disc has a uniform appearance of an image printed onto the printable layer across the area between the predetermined radius and the second outer radius. The printable layer may, for example, be made of paper, plastic, polyvinyl pyrrolidone (PVP), polyvinyl alcohol (PVOH), polyvinyl acetate (PVA), polymers, synthetic resins, or combinations thereof.

In accordance with an embodiment herein, the optical disc includes one or more dye layers formed over the grooves and lands, a reflective layer formed over the one or more dye layers, and a protective layer formed over the reflective layer. The one or more dye layers may, for example, be made of cyanine, phthalocyanine, azo compounds, formazan, or combinations thereof. The reflective layer may, for example, be made of metals, metallic alloys, metal-containing compounds, or combinations thereof.

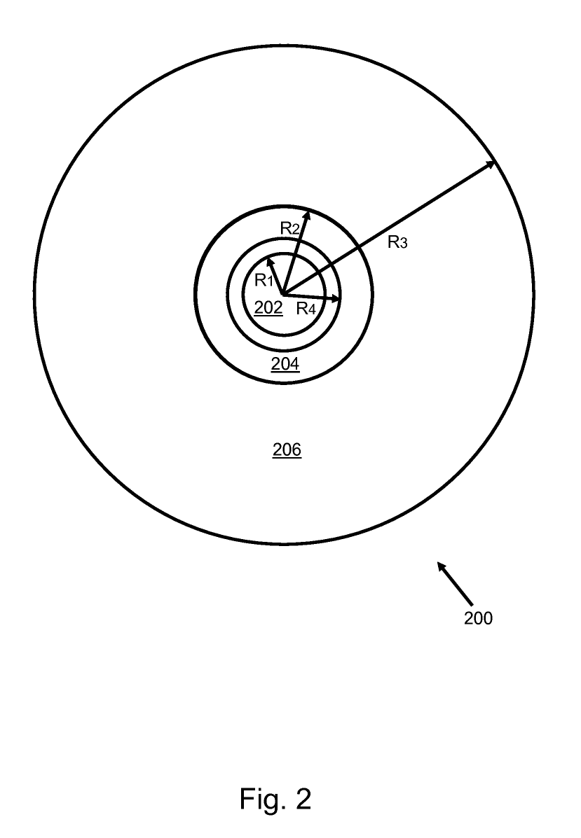

FIG. 2 illustrates an optical disc 200, in accordance with an embodiment herein. Optical disc 200 includes a punch area 202 at a centre of optical disc 200, a hub area 204 surrounding punch area 202, and a data area 206 surrounding hub area 204. Hub area 204 is formed between a first inner radius and a first outer radius, shown as R₁ and R₂ in FIG. 2. Data area 206 is formed between a second inner radius and a second outer radius, shown as R₂ and R₃ in FIG. 2. With reference to FIG. 2, the second inner radius is equal to the first outer radius. The second inner radius is greater than the first inner radius (i.e., R₂>R₁), and the second outer radius is greater than the first outer radius (i.e., R₃>R₂).

Hub area 204 and data area 206 include grooves and lands formed between a first predetermined radius, shown as R₄ in FIG. 2, and the second outer radius, R₃. The grooves and lands may be modulated to a predetermined frequency. The first predetermined radius, R₄, lies between the first inner radius, R₁, and the first outer radius, R₂, as shown in FIG. 2. The formation of grooves and lands enables uniform appearance across an area between the first predetermined radius, R₄, and the second outer radius, R₃, as shown in FIG. 2.

Optical disc 200 includes a printable layer (not shown in FIG. 2) formed between the first predetermined radius and the second outer radius, wherein the optical disc has a uniform appearance of an image printed onto the printable layer across the area between the first predetermined radius and the second outer radius. The printable layer may, for example, be made of paper, plastic, polyvinyl pyrrolidone (PVP), polyvinyl alcohol (PVOH), polyvinyl acetate (PVA), polymers, synthetic resins, or combinations thereof.

In accordance with an embodiment herein, optical disc 200 includes one or more dye layers (not shown in FIG. 2) formed over the grooves and lands, a reflective layer (not shown in FIG. 2) formed over the one or more dye layers, and a protective layer (not shown in FIG. 2) formed over the reflective layer. A portion of the one or more dye layers formed over data area 206, between the second inner radius and the second outer radius, is capable of recording and/or reproducing data. In accordance with a specific embodiment herein, the one or more dye layers formed over hub area 204 and data area 206, between the first predetermined radius and the second outer radius, are capable of recording and/or reproducing data, as per new or modified industry standards. The one or more dye layers may, for example, be made of cyanine, phthalocyanine, azo compounds, formazan, or combinations thereof. The reflective layer may, for example, be made of metals, metallic alloys, metal-containing compounds, or combinations thereof. The protective layer protects the underlying layers, and may, for example, be made of an acrylic lacquer.

Optical disc 200 may, for example, be of any suitable type and size. Examples of optical disc 200 include, but are not limited to, Compact Discs (CDs), Digital Versatile Discs (DVDs), High-Definition DVDs (HD-DVDs), High-Definition Versatile Discs (HVDs), Blu-ray Discs (BDs), MiniDiscs (MDs), Universal Media Discs (UMDs), and Laser Discs (LDs). Optical disc 200 may, for example, be recordable, re-writable, read-only memory, or random access memory. The overall radius of optical disc 200 may, for example, range between 30 mm and 65 mm. The first inner radius and the first outer radius may, for example, range between 7.5 mm and 16.5 mm. The second inner radius and the second outer radius may, for example, range between 16.5 mm and 65 mm.

FIG. 2 is merely an example, which should not unduly limit the scope of the claims herein. One of ordinary skill in the art would recognize many variations, alternatives, and modifications of embodiments herein.

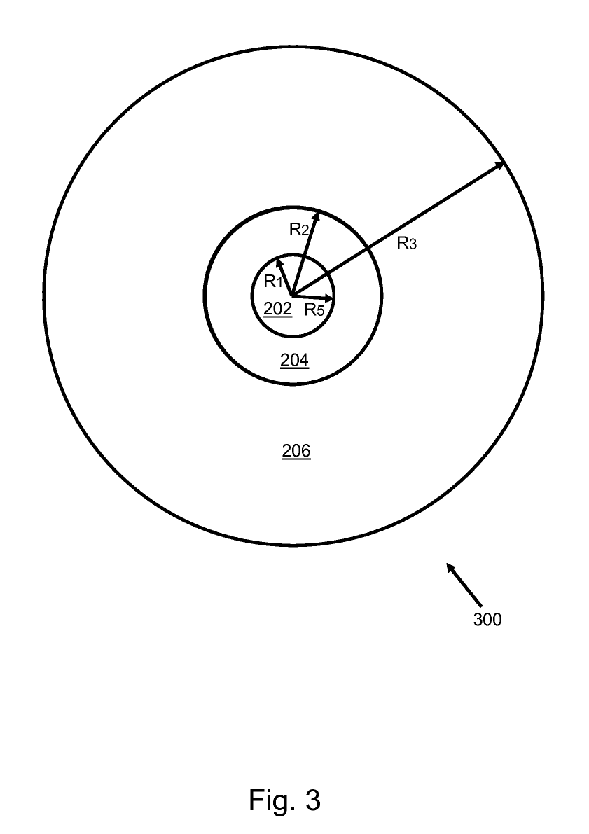

FIG. 3 illustrates an optical disc 300, in accordance with another embodiment herein. Optical disc 300 includes punch area 202, hub area 204, and data area 206. Hub area 204 is formed between the first inner radius, R₁, and the first outer radius, R₂. Data area 206 is formed between the second inner radius, R₂, and the second outer radius, R₃. With reference to FIG. 3, the second inner radius is equal to the first outer radius. The second inner radius is greater than the first inner radius (i.e., R₂>R₁), and the second outer radius is greater than the first outer radius (i.e., R₃>R₂).

Hub area 204 and data area 206 include grooves and lands formed between a second predetermined radius, shown as R₅ in FIG. 3, and the second outer radius, R₃. The grooves and lands may be modulated to a predetermined frequency. With reference to FIG. 3, the second predetermined radius, R₅, is equal to the first inner radius, R₁. The formation of grooves and lands enables uniform appearance across hub area 204 and data area 206, as shown in FIG. 3.

Optical disc 300 includes a printable layer (not shown in FIG. 3) formed between the second predetermined radius and the second outer radius, wherein the optical disc has a uniform appearance of an image printed onto the printable layer across hub area 204 and data area 206. The printable layer may, for example, be made of paper, plastic, polyvinyl pyrrolidone (PVP), polyvinyl alcohol (PVOH), polyvinyl acetate (PVA), polymers, synthetic resins, or combinations thereof.

In accordance with an embodiment herein, optical disc 300 includes one or more dye layers (not shown in FIG. 3) formed over the grooves and lands, a reflective layer (not shown in FIG. 3) formed over the one or more dye layers, and a protective layer (not shown in FIG. 3) formed over the reflective layer. A portion of the one or more dye layers formed over data area 206, between the second inner radius and the second outer radius, is capable of recording and/or reproducing data. In accordance with a specific embodiment herein, the one or more dye layers formed over hub area 204 and data area 206, between the second predetermined radius and the second outer radius, are capable of recording and/or reproducing data, as per new or modified industry standards. The one or more dye layers may, for example, be made of cyanine, phthalocyanine, azo compounds, formazan, or combinations thereof. The reflective layer may, for example, be made of metals, metallic alloys, metal-containing compounds, or combinations thereof. The protective layer protects the underlying layers, and may, for example, be made of an acrylic lacquer.

Optical disc 300 may, for example, be of any suitable type and size. Examples of optical disc 300 include, but are not limited to, Compact Discs (CDs), Digital Versatile Discs (DVDs), High-Definition DVDs (HD-DVDs), High-Definition Versatile Discs (HVDs), Blu-ray Discs (BDs), MiniDiscs (MDs), Universal Media Discs (UMDs), and Laser Discs (LDs). Optical disc 300 may, for example, be recordable, re-writable, read-only memory, or random access memory. The overall radius of optical disc 300 may, for example, range between 30 mm and 65 mm. The first inner radius and the first outer radius may, for example, range between 7.5 mm and 16.5 mm. The second inner radius and the second outer radius may, for example, range between 16.5 mm and 65 mm.

FIG. 3 is merely an example, which should not unduly limit the scope of the claims herein. One of ordinary skill in the art would recognize many variations, alternatives, and modifications of embodiments herein.

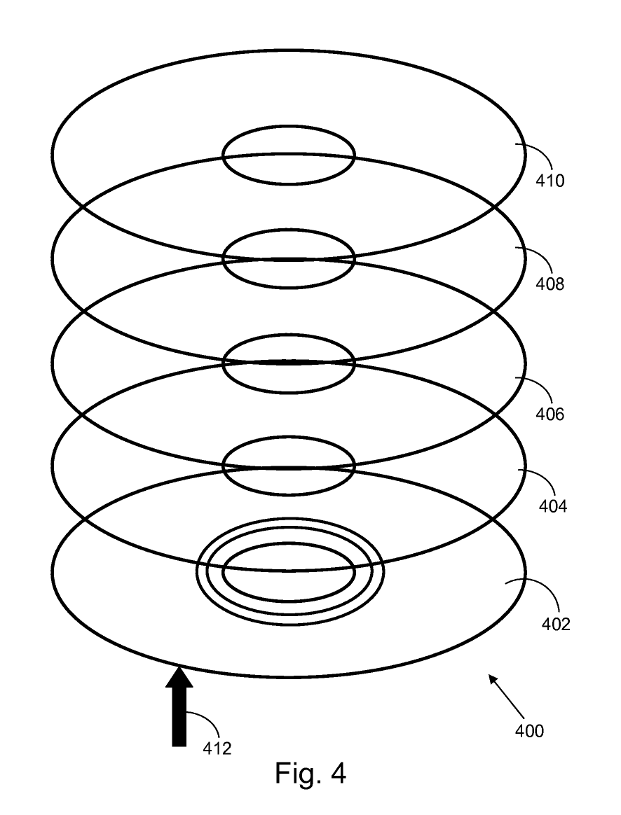

FIG. 4 illustrates various layers of an optical disc 400, in accordance with an embodiment herein. With reference to FIG. 4, optical disc 400 includes a substrate 402 with a groove-containing surface, a dye layer 404 on the groove-containing surface, a reflective layer 406 on dye layer 404, and a protective layer 408 on reflective layer 406. A printed material 410 is printed on protective layer 408.

The groove-containing surface, dye layer 404, reflective layer 406, protective layer 408 and printed material 410 are located over both a hub area and a data area of optical disc 400. The hub area contains no data and is located surrounding a central punch area in optical disc 400.

Printed material 410 has a uniform appearance across the hub area and the data area of optical disc 400.

An arrow 412 represents the direction of a light beam falling on optical disc 400. The light beam is reflected off reflective layer 406, and is received by a light detector. This enables tracking of the light beam on optical disc 400.

FIG. 4 is merely an example, which should not unduly limit the scope of the claims herein. It is to be understood that the specific designation for optical disc 400 is for the convenience of reading and is not to be construed as limiting optical disc 400 to specific numbers, shapes, sizes, types, or arrangements of various layers of optical disc 400. One of ordinary skill in the art would recognize many variations, alternatives, and modifications of embodiments herein.

In accordance with another embodiment herein, an optical disc includes a substrate with a groove-containing surface, a dye layer on the groove-containing surface, a reflective layer on the dye layer and a printed material on the reflective layer. The groove-containing surface, the dye layer, the reflective layer and the printed material are located over both a hub area and a data area of the optical disc. The hub area contains no data and is located surrounding a central punch area in the optical disc. The groove-containing surface may include grooves that are modulated to a predetermined frequency. The printed material has a uniform appearance across the hub area and the data area of the optical disc.

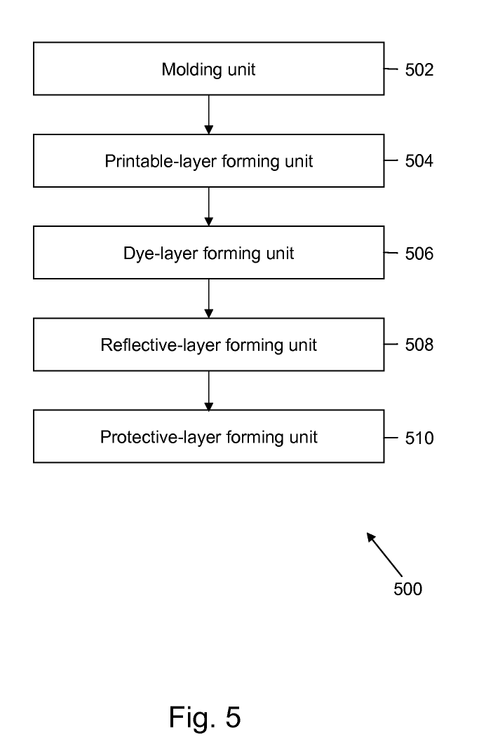

FIG. 5 illustrates a system 500 for manufacturing an optical disc, in accordance with an embodiment herein. System 500 includes a molding unit 502, a printable-layer forming unit 504, a dye-layer forming unit 506, a reflective-layer forming unit 508, and a protective-layer forming unit 510.

Molding unit 502 is adapted to mold a polymeric material to form a substrate. The polymeric material may, for example, be a polycarbonate or a plastic. The substrate so formed includes a hub area and a data area. The hub area is formed between a first inner radius and a first outer radius, while the data area is formed between a second inner radius and a second outer radius. The second inner radius is greater than the first inner radius, and the second outer radius is greater than the first outer radius.

Molding unit 502 is also adapted to form grooves and lands on the substrate between a predetermined radius and the second outer radius, where the predetermined radius lies at the first inner radius or between the first inner radius and the first outer radius.

Molding unit 502 may, for example, be an injection mold adapted to form a substrate with a hub area and a data area, and form grooves and lands, as required. The overall radius of the optical disc to be manufactured may, for example, range between 30 mm and 65 mm. The first inner radius and the first outer radius may, for example, range between 7.5 mm and 16.5 mm. The second inner radius and the second outer radius may, for example, range between 16.5 mm and 65 mm.

Printable-layer forming unit 504 is adapted to form a printable layer on the substrate between the predetermined radius and the second outer radius. This enables uniform appearance of an image printed onto the printable layer across an area between the predetermined radius and the second outer radius. The printable layer may, for example, be made of paper, plastic, polyvinyl pyrrolidone (PVP), polyvinyl alcohol (PVOH), polyvinyl acetate (PVA), polymers, synthetic resins, or combinations thereof.

Dye-layer forming unit 506 is adapted to form one or more dye layers over the grooves and lands. The number of dye layers may, for example, depend on the type of an optical disc to be manufactured. The one or more dye layers may, for example, be made of an organic dye. Examples of organic dyes include, but are not limited to, cyanine, phthalocyanine, azo compounds, and formazan.

Reflective-layer forming unit 508 is adapted to form a reflective layer over the one or more dye layers. Reflective-layer forming unit 508 may, for example, perform metallization over the one or more dye layers. The reflective layer may, for example, be made of metals, metallic alloys, metal-containing compounds, or combinations thereof.

Protective-layer forming unit 510 is adapted to form a protective layer over the reflective layer. Protective-layer forming unit 510 may, for example, perform spin coating to form the protective layer. The protective layer may, for example, be made of an acrylic lacquer.

FIG. 5 is merely an example, which should not unduly limit the scope of the claims herein. One of ordinary skill in the art would recognize many variations, alternatives, and modifications of embodiments herein. For example, for manufacturing a re-writable optical disc, dye-layer forming unit 506 may be replaced with a sandwiching unit that is adapted to form a sandwich of metals.

Various embodiments herein provide a system for manufacturing an optical disc. The system includes means for molding a polymeric material to form a substrate. As described above, the substrate includes a hub area formed between a first inner radius and a first outer radius, and a data area formed between a second inner radius and a second outer radius. The second inner radius is greater than the first inner radius, and the second outer radius is greater than the first outer radius. The means for molding is adapted to form grooves and lands over the substrate between a predetermined radius and the second outer radius, where the predetermined radius lies at the first inner radius or between the first inner radius and the first outer radius.

The system also includes means for forming a printable layer between the predetermined radius and the second outer radius. This enables uniform appearance of an image printed onto the printable layer across an area between the predetermined radius and the second outer radius.

The system further includes means for forming one or more dye layers over the grooves and lands, means for forming a reflective layer over the one or more dye layers, and means for forming a protective layer over the reflective layer.

An example of the means for molding is, but not limited to, molding unit 502. An example of the means for forming the printable layer is, but not limited to, printable-layer forming unit 504. An example of the means for forming the one or more dye layers is, but not limited to, dye-layer forming unit 506. An example of the means for forming the reflective layer is, but not limited to, reflective-layer forming unit 508. An example of the means for forming the protective layer is, but not limited to, protective-layer forming unit 510.

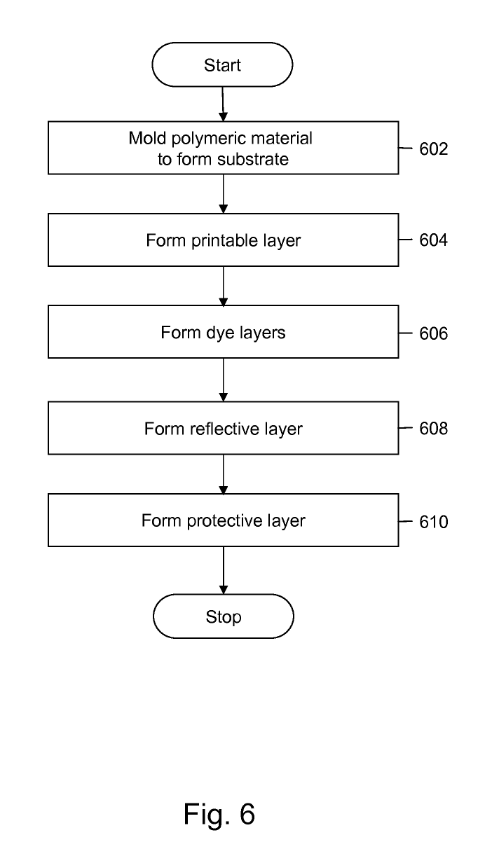

FIG. 6 illustrates a method of manufacturing an optical disc, in accordance with an embodiment herein. The method is illustrated as a collection of steps in a logical flow diagram, which represents a sequence of steps that can be implemented in hardware, software, or a combination thereof.

At step 602, a polymeric material is molded to form a substrate. The substrate so formed includes a hub area and a data area. The hub area is formed between a first inner radius and a first outer radius, while the data area is formed between a second inner radius and a second outer radius. The second inner radius is greater than the first inner radius, and the second outer radius is greater than the first outer radius. Grooves and lands are formed on the substrate between a predetermined radius and the second outer radius, where the predetermined radius lies at the first inner radius or between the first inner radius and the first outer radius.

In accordance with an embodiment herein, step 602 involves injection molding the polymeric material against an injection mold. The polymeric material used at step 602 may, for example, be a polycarbonate or a plastic.

At step 604, a printable layer is formed on the substrate between the predetermined radius and the second outer radius. This enables uniform appearance of an image printed onto the printable layer across an area between the predetermined radius and the second outer radius. The printable layer may, for example, be made of paper, plastic, polyvinyl pyrrolidone (PVP), polyvinyl alcohol (PVOH), polyvinyl acetate (PVA), polymers, synthetic resins, or combinations thereof.

At step 606, one or more dye layers are formed over the grooves and lands. As mentioned above, the number of dye layers may, for example, depend on the type of an optical disc to be manufactured. The one or more dye layers may, for example, be made of an organic dye. Examples of organic dyes include, but are not limited to, cyanine, phthalocyanine, azo compounds, and formazan.

At step 608, a reflective layer is formed over the one or more dye layers. Step 608 may, for example, involve metallization. The reflective layer may, for example, be made of metals, metallic alloys, metal-containing compounds, or combinations thereof.

At step 610, a protective layer is formed over the reflective layer. Step 610 may, for example, involve spin coating. The protective layer may, for example, be made of an acrylic lacquer. The protective layer protects the underlying layers from damage.

It should be noted here that steps 602-610 are only illustrative and other alternatives can also be provided where steps are added, one or more steps are removed, or one or more steps are provided in a different sequence without departing from the scope of the claims herein. In one example, steps 604 may be performed after steps 606-610. In another example, for manufacturing a re-writable disc, step 606 may be replaced with the step of forming a sandwich of metals.

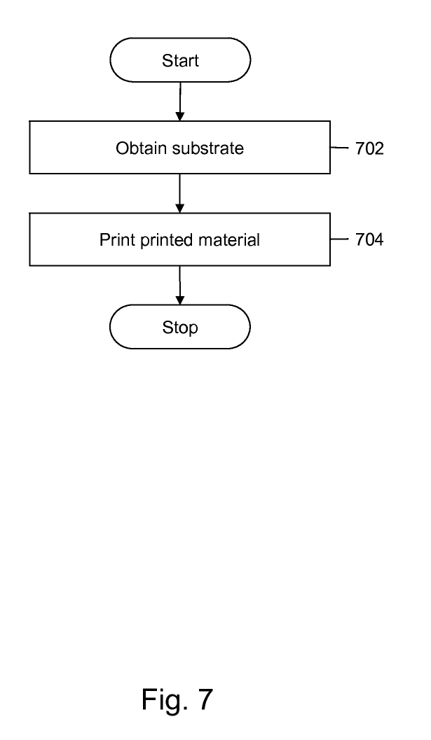

FIG. 7 illustrates a method of manufacturing an optical disc, in accordance with another embodiment herein. The method is illustrated as a collection of steps in a logical flow diagram, which represents a sequence of steps that can be implemented in hardware, software, or a combination thereof.

At step 702, a substrate of the optical disc is obtained. The substrate includes a groove-containing surface, a dye layer on the groove-containing surface, and a reflective layer on the dye layer. The substrate may also include a protective layer over the reflective layer.

At step 704, a printed material is printed on the reflective layer. Step 704 may, for example, involve forming a thin layer of a printing ink over the reflective layer.

The groove-containing surface, the dye layer, the reflective layer and the printed material are located over both a hub area and a data area of the optical disc. The hub area contains no data and is located surrounding a central punch area in the optical disc. The printed material has a uniform appearance across the hub area and the data area of the optical disc.

It should be noted here that steps 702-704 are only illustrative and other alternatives can also be provided where steps are added, one or more steps are removed, or one or more steps are provided in a different sequence without departing from the scope of the claims herein.

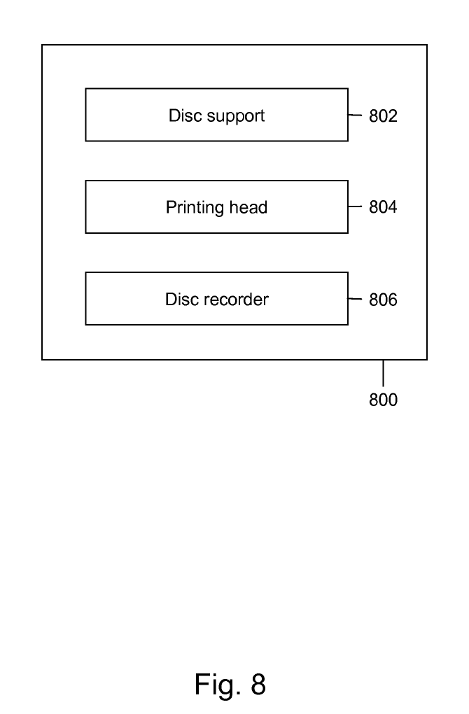

FIG. 8 illustrates a system 800 for printing on an optical disc, in accordance with an embodiment herein. System 800 includes a disc support 802, a printing head 804, and a disc recorder 806. As described earlier, the optical disc includes a hub area formed between a first inner radius and a first outer radius, and a data area formed between a second inner radius and a second outer radius. The hub area and the data area include grooves and lands formed between a predetermined radius and the second outer radius, where the predetermined radius lies at the first inner radius or between the first inner radius and the first outer radius. The optical disc also includes a printable layer formed between the predetermined radius and the second outer radius.

Disc support 802 is adapted to receive an optical disc. Disc support 802 may, for example, be extendable and retractable between a loading position and a processing position.

Printing head 804 is movable, and is adapted to print an image onto the printable layer of the optical disc in the processing position. The image so printed has a uniform appearance across an area between the predetermined radius and the second outer radius. Printing head 804 may, for example, be a part of an inkjet printer.

Disc recorder 806 is adapted to record data onto the optical disc. Disc recorder 806 is also adapted to reproduce data recorded onto the optical disc.

System 800 may, for example, be implemented in a personal computer or a laptop. A computer typically includes a processor for executing various programs, a display screen for displaying one or more user interfaces to a user, and one or more input devices for providing inputs from the user. The computer may, for example, include a single device that is capable of printing and recording on optical discs. In such a case, disc support 802, printing head 804 and disc recorder 806 are provided together as a disc printer and recorder.

FIG. 8 is merely an example, which should not unduly limit the scope of the claims herein. One of ordinary skill in the art would recognize many variations, alternatives, and modifications of embodiments herein. For example, system 800 may not necessarily include disc recorder 806.

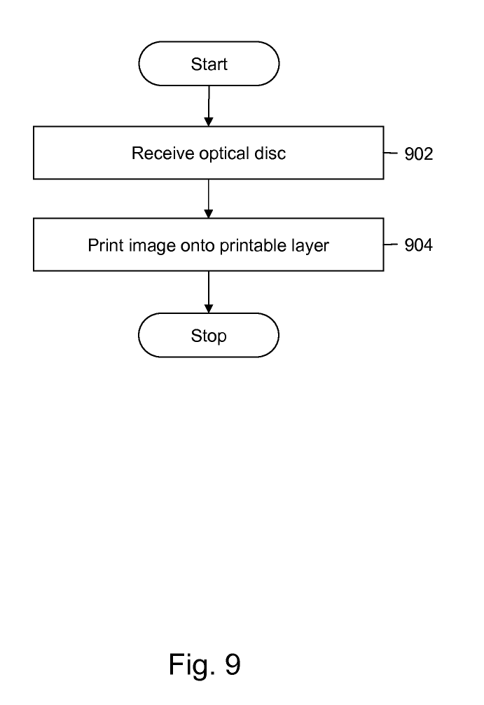

FIG. 9 illustrates a method of printing on an optical disc, in accordance with an embodiment herein. The method is illustrated as a collection of steps in a logical flow diagram, which represents a sequence of steps that can be implemented in hardware, software, or a combination thereof.

As described earlier, the optical disc includes a hub area formed between a first inner radius and a first outer radius, and a data area formed between a second inner radius and a second outer radius. The hub area and the data area include grooves and lands formed between a predetermined radius and the second outer radius, where the predetermined radius lies at the first inner radius or between the first inner radius and the first outer radius. The optical disc also includes a printable layer formed between the predetermined radius and the second outer radius.

At step 902, a disc support receives the optical disc.

At step 904, an image is printed onto the printable layer of the optical disc through a printing head. The image so printed has a uniform appearance across an area between the predetermined radius and the second outer radius.

It should be noted here that steps 902-904 are only illustrative and other alternatives can also be provided where steps are added, one or more steps are removed, or one or more steps are provided in a different sequence without departing from the scope of the claims herein.

As described earlier, a region is said to have a uniform appearance when it has substantially the same intensity of whiteness across the region. In accordance with an embodiment herein, the intensity of whiteness is measured in terms of the Lab color space, using a modified form of spectrophotometer. An example of such a spectrophotometer is the Gretag-Macbeth spectroscan.

The intensity of whiteness may be measured with reference to a reference surface, which is considered to be absolute white (i.e., having a value of component ‘L’=100). For example, the relative luminance of a test surface of an optical disc may be calculated by comparing the luminance of the test surface and the reference surface. The intensity of whiteness may then be calculated using the cube root of the relative luminance.

In one implementation, the spectroscan measures the intensity of whiteness at various points on a test surface of an optical disc to be tested. This ensures that the test surface has the same intensity of whiteness across a hub area and a data area of the optical disc. In another implementation, the spectroscan measures the intensity of whiteness at one or more points on a hub area of an optical disc to be tested.

Table 1 is an exemplary table illustrating values of component ‘L’ measured across a plurality of optical discs.

| Optical discs with | Optical discs with |
|---|---|
| non-uniform appearance | uniform appearance |
| 82.1361 | 93.2324 |
| 83.7975 | 92.9352 |
| 82.4889 | 93.0396 |
| 83.7537 | 92.9093 |
| 83.3259 | 93.1912 |
| 82.6276 | 92.5427 |
| 83.7001 | 92.7766 |
| 82.3474 | 92.6329 |
| 83.4282 | 94.0206 |
| 82.6082 | 93.4651 |
| 82.8828 | 93.3023 |
| 83.0794 | 93.3608 |
| 82.7887 | 92.9652 |
| 82.0119 | 93.7360 |
| 83.4945 | 92.7625 |
| 83.3195 | 92.6862 |
| 84.1535 | 94.2648 |
| 81.9244 | 92.9507 |
| 83.0992 | 92.9366 |
| 82.9257 | 92.9134 |
| 82.5222 | 93.0791 |
| 82.0416 | 92.5212 |
| 82.5354 | 92.6431 |
| 82.2809 | 93.0864 |
| 82.2346 | 93.6384 |
| 83.5082 | 93.3692 |
| 82.6197 | 93.1760 |
| 82.3552 | 93.2809 |
| 83.0735 | 92.9533 |
| 83.1211 | 93.5576 |
| 82.1665 | 93.4058 |
| 83.6309 | 92.0324 |
| 82.5804 | 92.9886 |
| 82.7567 | 93.8536 |
| 83.4238 | 92.9324 |

With reference to Table 1,
Column ‘Optical discs with non-uniform appearance’ denotes values of component ‘L’ measured at a point on a hub area of 35 optical discs with non-uniform appearance.
Column ‘Optical discs with uniform appearance’ denotes values of component ‘L’ measured at a point on a hub area of 35 optical discs with uniform appearance.
The values of component ‘L’ have been performed based on the Lab color space.
For each optical disc, the point on the hub area has been taken at a radius of 22 mm.

It can be observed that values of component ‘L’ fall in a range of 81 and 85 for hub areas of the optical discs with non-uniform appearance, while values of component ‘L’ fall in a range of 92 and 95 for hub areas of the optical discs with uniform appearance. Values of component ‘L’ fall in the same range of 92 and 95 for data areas of the optical discs with uniform appearance. Therefore, such optical discs have a uniform appearance across their hub areas and data areas.

Embodiments herein provide an optical disc with uniform appearance. The optical disc includes a hub area formed between a first inner radius and a first outer radius, and a data area formed between a second inner radius and a second outer radius. The hub area and the data area include grooves and lands formed between a predetermined radius and the second outer radius, where the predetermined radius lies at the first inner radius or between the first inner radius and the first outer radius. This enables uniform appearance across an area between the predetermined radius and the second outer radius.

In addition, the optical disc includes a printable layer formed between the predetermined radius and the second outer radius. This enables uniform appearance of an image printed onto a printable layer of such an optical disc.

Consequently, the utility and acceptability of the optical disc is enhanced. This overcomes various technical hindrances in operational and marketing aspects.

What is claimed is:

1. An optical disc comprising:
a punch area at a centre of said optical disc;
a hub area surrounding said punch area, said hub area formed between a first inner radius and a first outer radius; and
a data area surrounding said hub area, said data area formed between a second inner radius and a second outer radius, wherein said second inner radius is greater than said first inner radius and said second outer radius is greater than said first outer radius,
further wherein said hub area and said data area comprise grooves and lands formed between a predetermined radius and said second outer radius, said predetermined radius lies at said first inner radius or between said first inner radius and said first outer radius, wherein the optical disc has a uniform appearance across an area between said predetermined radius and said second outer radius.

2. The optical disc of claim 1 further comprising a printable layer formed between said predetermined radius and said second outer radius, wherein the optical disc has a uniform appearance of an image printed onto said printable layer across said area between said predetermined radius and said second outer radius.

3. The optical disc of claim 2, wherein said printable layer is made of at least one material selected from the group consisting of paper, plastic, polyvinyl pyrrolidone (PVP), polyvinyl alcohol (PVOH), polyvinyl acetate (PVA), polymers and synthetic resins.

4. The optical disc of claim 1 further comprising:
one or more dye layers formed over said grooves and lands;
a reflective layer formed over said one or more dye layers; and
a protective layer formed over said reflective layer.

5. The optical disc of claim 4, wherein said one or more dye layers are made of at least one dye selected from the group consisting of cyanine, phthalocyanine, azo compounds and formazan.

6. The optical disc of claim 4, wherein said reflective layer is made of at least one reflective material selected from the group consisting of metals, metallic alloys, and metal compounds.

7. The optical disc of claim 1, wherein said first inner radius and said first outer radius range between 7.5 mm and 16.5 mm, and said second inner radius and said second outer radius range between 16.5 mm and 65 mm.

8. A method of manufacturing an optical disc, the method comprising:
molding a polymeric material to form a substrate, said substrate comprising a hub area formed between a first inner radius and a first outer radius, and a data area formed between a second inner radius and a second outer radius, wherein said second inner radius is greater than said first inner radius and said second outer radius is greater than said first outer radius, said substrate comprises grooves and lands formed between a predetermined radius and said second outer radius, said predetermined radius lies at said first inner radius or between said first inner radius and said first outer radius; and
forming a printable layer between said predetermined radius and said second outer radius, wherein the optical disc has a uniform appearance of an image printed onto said printable layer across an area between said predetermined radius and said second outer radius.

9. The method of claim 8, wherein said molding comprises injection molding.

10. The method of claim 8, wherein said printable layer is made of at least one material selected from the group consisting of paper, plastic, polyvinyl pyrrolidone (PVP), polyvinyl alcohol (PVOH), polyvinyl acetate (PVA), polymers and synthetic resins.

11. The method of claim 8 further comprising:
forming one or more dye layers over said grooves and lands;
forming a reflective layer over said one or more dye layers; and
forming a protective layer over said reflective layer.

12. The method of claim 11, wherein said one or more dye layers are made of at least one dye selected from the group consisting of cyanine, phthalocyanine, azo compounds and formazan.

13. The method of claim 11, wherein said reflective layer is made of at least one reflective material selected from the group consisting of metals, metallic alloys, and metal compounds.

14. A method of printing on an optical disc, said optical disc comprising a hub area formed between a first inner radius and a first outer radius, and a data area formed between a second inner radius and a second outer radius, wherein said second inner radius is greater than said first inner radius and said second outer radius is greater than said first outer radius, grooves and lands are formed on said optical disc between a predetermined radius and said second outer radius, said predetermined radius lies at said first inner radius or between said first inner radius and said first outer radius, said optical disc further comprises a printable layer formed between said predetermined radius and said second outer radius, the method comprising:
receiving said optical disc on a disc support; and
printing an image onto said printable layer of said optical disc through a printing head, wherein the optical disc has a uniform appearance of said image across an area between said predetermined radius and said second outer radius.

15. A system for printing on an optical disc, said optical disc comprising a hub area formed between a first inner radius and a first outer radius, and a data area formed between a second inner radius and a second outer radius, wherein said second inner radius is greater than said first inner radius and said second outer radius is greater than said first outer radius, grooves and lands are formed on said optical disc between a predetermined radius and said second outer radius, said predetermined radius lies at said first inner radius or between said first inner radius and said first outer radius, said optical disc further comprises a printable layer formed between said predetermined radius and said second outer radius, the system comprising:
a disc support for receiving said optical disc; and
a printing head for printing an image onto said printable layer of said optical disc, wherein the optical disc has a uniform appearance of said image across an area between said predetermined radius and said second outer radius.

16. The system of claim 15 further comprising a disc recorder for recording data onto said optical disc.

17. An optical disc comprising a groove-containing surface, a dye layer on said groove-containing surface, a reflective layer on said dye layer, and a printed material on said reflective layer, wherein said groove-containing surface, said dye layer, said reflective layer and said printed material are located over both a hub area and a data area of said optical disc, wherein said hub area contains no data and is located surrounding a central punch area in said optical disc, and said printed material has a uniform appearance across said hub area and said data area of said optical disc.

18. A method of manufacturing an optical disc, the method comprising:
obtaining a substrate comprising a groove-containing surface, a dye layer on said groove-containing surface, and a reflective layer on said dye layer; and
printing a printed material on said reflective layer, wherein said groove-containing surface, said dye layer, said reflective layer and said printed material are located over both a hub area and a data area of said optical disc, wherein said hub area contains no data and is located surrounding a central punch area in said optical disc, and said printed material has a uniform appearance across said hub area to said data area of said optical disc.
